(19) United States
(12) Patent Application Publication
(10) Pub. No.: US 2015/0066529 A1
(43) Pub. Date: Mar. 5, 2015

(54) DYNAMIC HEALTH DATA TASK-BASED TRANSITION OF CARE

(71) Applicant: Genesys Telecommunications Laboratories, Inc., Daly City, CA (US)

(72) Inventors: Robert Lattuca, Sydney (AU); Sean Coleman, Melbourne (AU); Sandra Judd, Canberra (AU); Simon Francis, Singapore (SG); Hayden Grant, Canberra (AU); Alan Ball, Brisbane (AU); Herbert Willi Artur Ristock, Walnut Creek, CA (US)

(21) Appl. No.: 14/449,025

(22) Filed: Jul. 31, 2014

Related U.S. Application Data
(60) Provisional application No. 61/872,607, filed on Aug. 30, 2013.

(51) Int. Cl. G06Q 50/22; G06Q 10/06

(52) U.S. Cl. CPC G06Q 50/22; G06Q 10/063114; G06Q 10/063112
USPC 705/2

(57) ABSTRACT

A workflow management system includes a processor and memory. The memory stores instructions that, when executed by the processor, cause the processor to identify an event received from an external system. The instructions further cause the processor to generate a work item corresponding to the event. The work item has a plurality of attributes. The instructions further cause the processor to assign the work item for distribution based on the attributes, and adjust at least one of a priority or a routing strategy for the work item according to a status of the work item.

### CROSS-REFERENCE TO RELATED APPLICATION

This application claims the benefit of U.S. Provisional Application No. 61/872,607, filed Aug. 30, 2013 (attorney docket 72949), the entire content of which is incorporated herein by reference.

### BACKGROUND

In a health care environment such as a hospital, workflow is made up of several separate processes that may be performed in parallel, concurrently, or sequentially to deliver an outcome. In the hospital context, for example, the care delivery system may include admission, assessment, diagnostics and treatment processes. Processes are often performed by many people within a similar timeframe, and each process May comprise a series of tasks.

Often times, delays in the delivery of health care processes, poor team collaboration, and inefficiencies in performing processes, such as lack of follow-through on tasks and allocation of tasks according to ease of completion rather than level of importance, are harmful to treatment efficacy and even patient safety. For example, when a task completion does not meet a desired standard or target service level, or the task is not completed at all, that component of the process is at risk. Delays in health care processes may create bottle necks that obstruct patient flow and quality of care. Further, in current health care environments, it can be difficult to trace a patient's progress, identify the best available person to perform a task at a given moment in time, and determine why certain tasks are taking longer than desired.

Although many health care environments utilize an electronic health record (EHR) system to store patient data, such systems have limited workflow and business process management functionality. Additionally, different EHR systems used by different practitioners (e.g., different physicians, hospitals, and pharmacies) may not be compatible with one another and thus are less effective in coordinating patient care. Further, such systems are generally only able to provide point-of-care data capture and cannot give a real-time view of workflow across several work processes. Accordingly, there is a need for a health care workflow management system that can provide real-time visibility of tasks (or work items) and resources, monitor tasks to completion, and control the priorities of individual tasks.

### SUMMARY

Embodiments of the present invention are directed to a workflow management system that includes a processor and a memory. The memory stores instructions that, when executed by the processor, cause the processor to identify an event received from an external system. The instructions further cause the processor to generate a work item corresponding to the event. The work item has a plurality of attributes. The instructions further cause the processor to assign the work item for distribution based on the attributes, and adjust at least one of a priority or a routing strategy for the work item according to a status of the work item.

According to one embodiment, the attributes include at least one of an urgency level, a target service level, a process type, or type of worker to perform the work item.

According to one embodiment, the target service level corresponds to an amount of elapsed time before the work item is distributed to a worker.

According to one embodiment, the status of the work item includes information about an approaching threshold of the target service level.

According to one embodiment, the instructions further cause the processor to send notifications to and receive acknowledgements from the worker. The notifications indicate a status of a work item.

According to one embodiment, the routing strategy for the work item is adjusted by sending a notification to a different worker.

According to one embodiment, the instructions further cause the processor to receive a record corresponding to the work item, and send a notification to a next worker in the workflow when the record is received.

According to one embodiment, the status of the work item includes information about availability of the record.

According to one embodiment, the priority or the routing strategy for the work item is adjusted based on business rules.

According to one embodiment, the instructions further cause the processor to distribute the work item to a worker based on the worker's skills and availability.

Embodiments of the present invention are also directed to a method for workflow management that includes identifying, by one or more processors, an event received from an external system; generating, by the one or more processors, a work item corresponding to the event, the work item having a plurality of attributes; assigning, by the one or more processors, the work item for distribution based on the attributes; and adjusting, by the one or more processors, at least one of a priority or a routing strategy for the work item according to a status of the work item.

According to one embodiment, the attributes include at least one of an urgency level, a target service level, a process type, or type of worker to perform the work item.

According to one embodiment, the target service level corresponds to an amount of elapsed time before the work item is distributed to a worker.

According to one embodiment, the status of the work item includes information about an approaching threshold of the target service level.

According to one embodiment, the method further includes sending, by the one or more processors, notifications to the worker and receiving, by the one or more processors, acknowledgements from the worker. The notifications indicate a status of a work item.

According to one embodiment, the routing strategy for the work item is adjusted by sending a notification to a different worker.

According to one embodiment, the method further includes receiving, by the one or more processors, a record corresponding to the work item, and generating, by the one or more processors, a notification when the record is received.

According to one embodiment, the status of the work item includes information about availability of the record.

According to one embodiment, the priority or the routing strategy for the work item is adjusted based on business rules.

According to one embodiment, the method further includes distributing, by the one or more processors, the work item to a worker based on the worker's skills and availability.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

The patent or application file contains at least one drawing executed in color. Copies of the patent or patent application publication with color drawings will be provided by the Office upon request and payment of the necessary fee.

FIG. 1A is a schematic block diagram of a workflow management system according to an embodiment of the invention.

FIG. 1B is a diagram of a global task list (GTL) task state machine according to an embodiment of the invention.

FIGS. 2-7 are block diagrams of a patient flow and a hospital workflow according to an embodiment of the invention.

FIGS. 8-19 are screen shots of different types of reports according to an embodiment of the invention.

FIG. 20A is a block diagram of a computing device according to an embodiment of the present invention.

FIG. 20B is a block diagram of a computing device according to an embodiment of the present invention.

FIG. 20C is a block diagram of a computing device according to an embodiment of the present invention.

FIG. 20D is a block diagram of a computing device according to an embodiment of the present invention.

FIG. 20E is a block diagram of a network environment including several computing devices according to an embodiment of the present invention.

### DETAILED DESCRIPTION

In general terms, embodiments of the present invention are directed to a workflow management system configured to manage tasks by consolidating task information from disparate systems into a global task list (GTL) so that an entire team of health care workers can view all work being done at any given time. The global task list helps to ensure that the appropriate resources, regardless of location, are proactively receiving more critical tasks, at an appropriate time and location. The workflow management system leverages relevant context such as associated business rules, escalation process, records (e.g., medical test results, assessment reports, patient records, and images such as x-rays, faxes, EHRs) to prioritize and route work items and delivery requests. Business rules are applied to promote consistency, efficiency, and the ability to more quickly adapt to changing circumstances. Flexible, automatic, real-time prioritization of tasks and interactions also helps to streamline health care processes. Additionally, in one embodiment dynamic routing of service requests to appropriate and available resources occurs across all processes according to factors such as urgency, task type, time and due date.

According to one embodiment, the workflow management system includes a Task-based Transition Of Care (TbTOC) system that manages tasks to completion by reducing bottle necks and keeping patient care on track. For example, the TbTOC system may notify the relevant worker when required paperwork or tests results are delayed, and may escalate tasks based on current status such as availability of medical test results. As another example, prioritization for completing lab tests could be based on patient criticality or status (e.g., inpatient or outpatient testing). The TbTOC system may also segment tasks (e.g., into different stages) and push them to a worker or workers with the appropriate skills, using skill-based assignments of tasks. Two or more workers may therefore complete parts of the same task concurrently. The TbTOC system may collect and store an amount of elapsed time for each worker and each stage of the task. Such automatic task allocation within process flows reduces the need for manual intervention by health care workers, which can decrease productivity.

According to one embodiment, the TbTOC system allows for automatic capture of task data as a task is being created, with minimal (or zero) user impact. In one embodiment, the TbTOC system provides the data across the entire workflow, irrespective of the task system and without requiring complex and time-consuming integration of systems. Task-level data granularity provides users with visibility into performance indicators as data is sourced from both task inputs and outputs. According to one embodiment, the TbTOC system allows for quicker identification and escalation of tasks that are outside of an acceptable standard. The TbTOC system may further provide transparency of individual patients' progress through the treatment cycle, producing improved patient outcomes and hospital efficiency.

According to one embodiment, the TbTOC system is a client server solution comprising multiple server products, desktop clients and portable devices for managing the allocation and transition of tasks to and between health care workers within and across a health care provider's departments.

One component of the TbTOC system is a workload management engine which may include a workload distribution engine. The workload distribution engine is configured to capture, prioritize and distribute tasks to the right and available health care worker to take action within the prescribed patient flow. Other functions of the TbTOC system may include tracking health care resource presence (e.g., availability), task notification and distribution, business rules management, and real time status and historical analytics reporting.

A. Workload Management Engine

According to one embodiment, the workload management engine includes a workload distribution engine (also referred to as “iWD”) that is configured to capture, prioritize and distribute tasks to individuals. The iWD engine is described in more detail in U.S. patent application Ser. No. 13/689,750 filed on Nov. 29, 2012 and entitled “Workload Distribution With Resource Awareness,” the entirety of which is hereby incorporated by reference. In one embodiment, the iWD engine uses open standards to simplify integration with existing hospital systems. The TbTOC system is thus designed to work alongside existing hospital systems rather than replace them. For example, in one embodiment, the iWD engine takes messages from an HL7 capture gateway, to avoid the need for complicated integration with other systems or the need to store any data itself. As such, according to an embodiment the iWD engine works in the background to add value to existing work processes. The iWD engine is used in retail, telecommunications, government, insurance and financial sectors to reduce human bottle necks in key workflows and monitor tasks through an organization.

According to embodiments of the present invention, a TbTOC system is added to a health care provider's information technology (IT) environment to monitor patient events (e.g., administration, radiology request, etc.) generated by existing clinical systems. A workload management engine starts a perpetual process of capture and prioritization using business rules to calculate the priority of work items and routing strategy for distribution of work items to a health care worker based on skills and availability.

According to one embodiment, the workload management engine is configured to monitor a task and all other tasks in its global task queue. Not only does this provide real time operational visibility for health administrators, but tasks are also constantly monitored and compared against the business rules for defined target service levels. The workload management engine can then automatically reorder tasks depending on priority and even adjust a routing strategy for tasks by escalating the tasks to secondary workers or teams (e.g., by sending notifications regarding the status of the tasks to the secondary workers or teams). Secondly, the workload management engine can monitor all tasks and adjust the timely distribution of preceding and succeeding tasks for the patient flow to avoid backlogs and bottle necks.

According to one embodiment, the TbTOC system provides functions different from those of an integration engine. Integration engines are typically used in health IT environments for providing message transport of patient data between existing health systems. They are usually complex, difficult to integrate and have limited human activity reporting capabilities. Secondly, they do not track health care worker tasks within a patient flow.

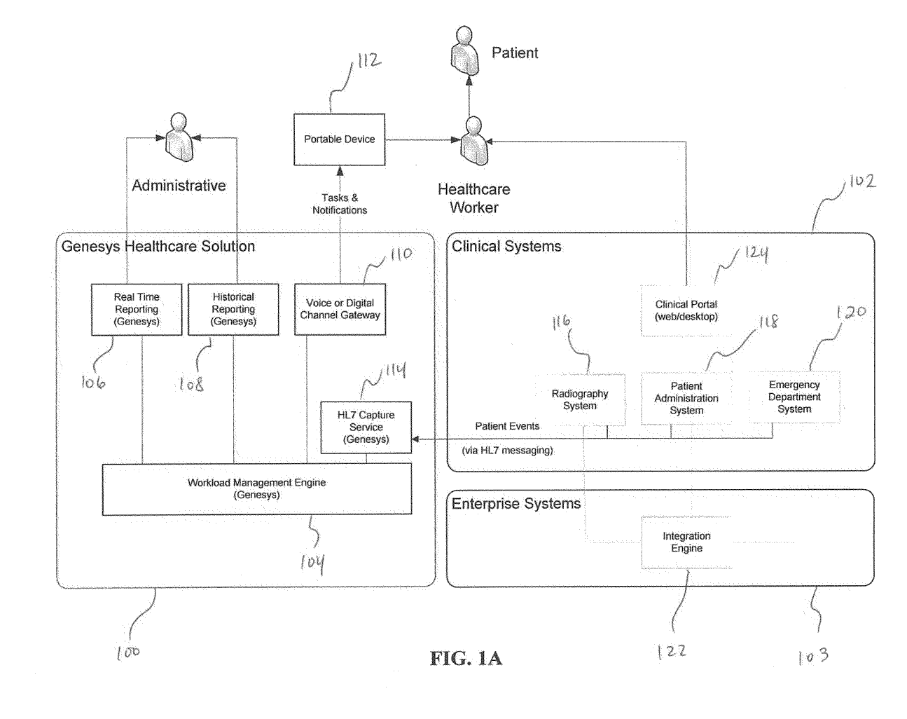

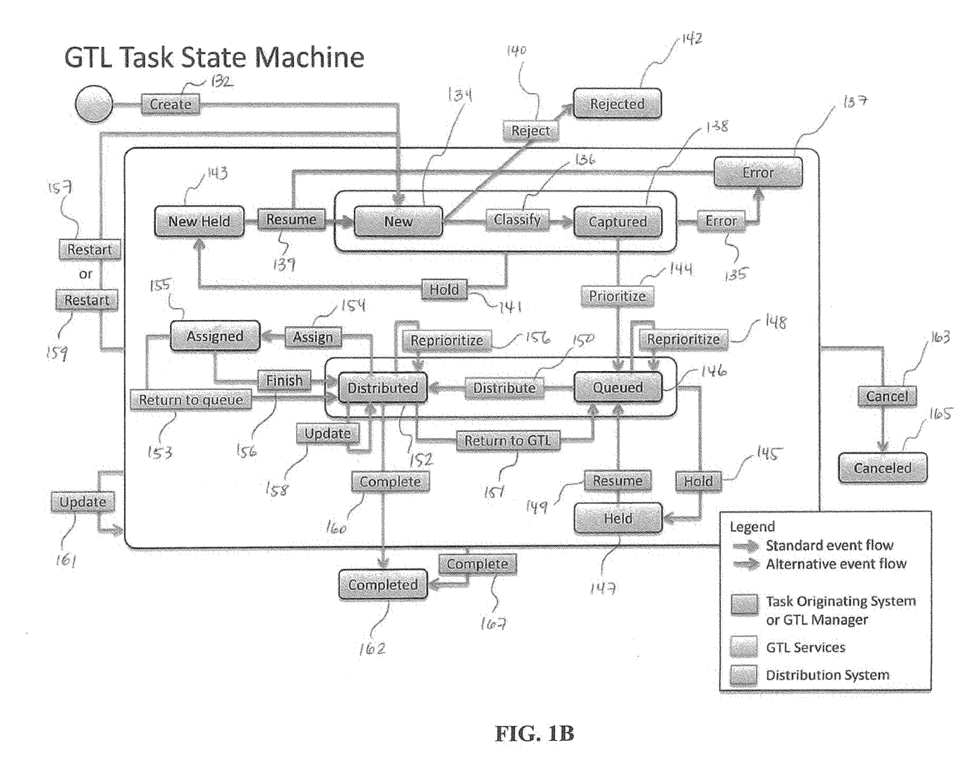

FIG. 1A is a block diagram of a TbTOC system 100 coupled to a health care provider IT system 102 that may be present at a health care provider, according to one embodiment of the invention. The TbTOC system includes a workload management engine 104 coupled to a real-time reporting engine 106, historical reporting engine 108, and a voice or digital channel gateway 110. The voice or digital channel gateway 110 is configured to communicate with a portable device 112 carried by, for example, a health care worker, to assign tasks, provide notifications, and receive status data to/from the health care worker.

The workload management engine 104 may include a workload distribution engine similar to the iWD engine described in U.S. patent application Ser. No. 13/689,750 filed on Nov. 29, 2012 and entitled “Workload Distribution With Resource Awareness,” the entirety of which is hereby incorporated by reference. According to one embodiment, the workload management engine 104 is coupled to a gateway 114 configured to receive and translate messages between the TbTOC system and the health care provider IT system. In this regard, the gateway 114 includes software and hardware components to receive messages adhering to, for example, an HL7 protocol. The received messages are then translated to a protocol understood by the workload management engine 104, and then forwarded to the workload management engine 104 for processing.

According to one embodiment, the TbTOC system performs a “light touch” integration. All patient events that occur in the existing clinical systems are captured by the TbTOC system without interruption to the source clinical systems or health care workers. The TbTOC system uses the capture adapter interface, which is shown in FIG. 1A as the HL7 capture gateway 114, to “listen” to (or identify) HL7 message events generated by the source clinical systems (e.g., the radiography system 116, patient administration system 118, and emergency department system 120 shown in FIG. 1A) and generates work items or tasks corresponding to those events. The health care provider may also have an enterprise system 103 that includes integration engine 122 to provide message transport of patient data between the existing clinical systems in FIG. 1A.

According to one embodiment, workflow management system behavior is controlled by a two-layer logic configuration. One layer includes a finite state machine (FSM) defining mandatory constraints and dependencies for the system. The other layer includes a set of more open, flexible rules that are configured to operate on top of the FSM. These rules are more freely configurable to provide flexibility in creating and managing tasks and work flows. The FSM may be embedded in the workflow management system and the constraints and dependencies may be defined by experts or other high-level authorities designated by the healthcare provider. In the FSM each task of the workflow management system's global task list has a particular state (or status), and the underlying logic of the FSM permits or blocks certain transitions from one state to another. The underlying logic for the FSM may be based on rules stored in a rules engine used by the workload management system. The rules may represent mandatory constraints and dependencies (or “must” rules) for certain tasks and transitions, For example, in the healthcare context a “must” rule may specify a sequence of actions (or tasks) for a certain type of patient, e.g., a patient who has been involved in a cycling accident must first be examined for head injuries before being examined for other injuries such as a shoulder injury. Other “must” rules” may relate to a particular resource that is associated with certain tasks, e.g., a patient must see a discharge nurse prior to being discharged from the hospital. In one embodiment, the FSM is implemented using State Chart Extensible Markup Language (SCXML).

The flexible, more freely configurable “open” rules could be created by various parties, such as healthcare workers, on the fly (e.g., during deployment of the system). These parties may not have knowledge of the mandatory constraints and dependencies of the FSM. As a result, some of the rules created by such parties may contradict the mandatory constraints and dependencies of the FSM. However, according to one embodiment the mandatory nature of the FSM constraints and dependencies blocks execution of any contradictory rules as a self-correction mechanism. For example, in the case of a conflict between a “must” rule of the FSM and an “open” rule, the “must” rule would take precedence.

According to one embodiment, FSM constraints and dependencies may be overridden by users with sufficient permissions. In such cases, the FSM constraints are not completely blocking. For example, a task that has been blocked from transitioning to a next state by a FSM constraint may be suspended at the current state (e.g., unfinished), and a new resume-task may be created with the same parameters as the unfinished task, at the desired next state. This suspend-move-resume action could be performed manually by a user such as a healthcare worker and may trigger an alert notification to an appropriate supervisor. An unauthorized suspend-move-resume action may also trigger an alert notification to an appropriate supervisor.

As an example, in the healthcare environment a “must” rule of the FSM may specify that a patient suffering from a particular ailment must be seen by a particular doctor. A task for one such patient may be stuck in its current state because the doctor was not available. The task therefore cannot transition to the next state in the patient's workflow. According to an embodiment, a healthcare worker may manually overcome a blocking condition (e.g., unavailability of a particular resource) at any point in the workflow by creating a new task, capturing and transferring the parameters of the blocked task (e.g., task attributes and associated rules) to the newly created task, and setting a status for the new task. The new task may then proceed through the patient's workflow. The capture and transfer of the old task's parameters preserves the history associated with the task for future reference.

FIG. 1B is a diagram of a global task list (GTL) task state machine according to an embodiment of the invention. According to one event flow, the workflow management system creates a new task at block 132. The task is in a “New” state as indicated by block 134. The task is classified at block 136 (e.g., according to task attributes) and transitions to a “Captured” state as indicated by block 138. Alternatively, the task may be rejected at block 140 and transitioned to a “Rejected” state as indicated by block 142. A rejected task may be a task that was improperly generated or that lacks sufficiently defined attributes. In one embodiment, a newly created and captured task may experience an error at block 135 and may be transitioned to an “Error” state as indicated by block 137. For example, the error may be a blocking condition. While in an “Error” state, the task may be resumed at block 139 by creating another new task, which is transitioned to a “New” state as indicated by block 134. A newly created and captured task may also be placed on hold at block 141 and transitioned to a “New Held” state as indicated by block 143. The “New Held” task may be resumed at block 139 and transitioned to a “New” state as indicated by block 134.

A task in a “Captured” state may be prioritized (e.g., according to task attributes and rules) at block 144 and transitioned to a “Queued” state as indicated by block 146. While in a “Queued” state, the task may be reprioritized (e.g., automatically reprioritized) at block 148 according to factors such as rules and availability of resources and records. In one embodiment, a task that is in a “Queued” state may be placed on hold at block 145 and transitioned to a “Held” state as indicated by block 147. While in a “Held” state, the task may be resumed at block 149 and transitioned back to a “Queued” state as indicated by block 146.

The “Queued” task may be distributed at block 150 and transitioned to a “Distributed” state as indicated by block 152. While in a “Distributed” state, the task may be assigned to a resource at block 154 for further processing and transitioned to an “Assigned” state as indicated by block 155. In one embodiment, a task that is in an “Assigned” state may be returned to queue at block 153 so that it is in a “Distributed” state as indicated by block 152. In another embodiment, the further processing is finished at block 156 and the task is transitioned to a “Distributed” state. The “Distributed” task may be reprioritized at block 156 according to factors such as rules and availability of resources and records. The “Distributed” task may be updated at block 158 to reflect changed attributes and conditions. The “Distributed” task may be completed at block 160 and transitioned to a “Completed” state as indicated by block 162.

In one embodiment, a task that is in a “Distributed” state may be returned to the global task list at block 151 for additional processing and transitioned to a “Queued” state as indicated by block 146.

The workflow process for the created task may be restarted at block 157 by a workload distribution system or restarted at block 159 by a global task list manager. The workflow process may also be updated based on, for example, new rules, at block 161. The workflow process may be completed at block 167 and the task transitioned to a “Completed” state as indicated by block 162. The workflow process may also be canceled at block 163 and the task transitioned to a “Canceled” state as indicated by block 165.

B. Resource Presence

According to an aspect of the present invention, effective task distribution involves pairing a task to the right resource (or person) with the right skills at the right time. The TbTOC system monitors the presence of health care workers during their shift so tasks can be allocated at the appropriate time. In one embodiment the workload management engine also monitors resource occupancy levels, such as how busy workers are, and availability of other resources such as equipment.

In one embodiment, presence information is updated by the health care worker using a portable device, an interactive voice response (IVR) system, or any suitable device that provides speech recognition, which updates or informs the workload management engine that they are either available for tasks or unavailable. When the worker tags that they are available, the workload management engine can distribute them a task, tag them unavailable until the task is completed, and then distribute them the next task. The workload management engine can also use shift work schedule information to determine that a worker is coming to a break or the end of their shift, and stop distributing tasks to them. Tasks and notifications are automatically sent from the workload management engine to the portable devices via the voice or digital channel gateway.

Other resources such as equipment may also indicate (or announce) their availability to the system, which may be communicated to users who will need those resources at some point in his or her workflow process. For example, an available resource may send an invitation for service to a user (e.g., a worker or a patient). The user may immediately accept the invitation or may make a reservation to use the resource at a later time. In one embodiment, when a user would like to use a resource but the resource is busy, the resource (or the system) may give the user the option of receiving a callback, either at a designated time or as soon as possible. The resource may then ping the user according to the scheduled callback or as soon as it becomes available.

C. Business Rules and Management

According to one embodiment, a rules engine is used by the TbTOC system. The rules engine is used for classifying, prioritizing and monitoring tasks in the global task list and also for determining a routing strategy for the distribution of tasks to workers.

Business rules can be modified and managed by authorized clinical directors and administrators. This provides functionality for them to modify task management behavior in times of an emergency crisis or to fast track a patient flow for a group of critically ill patients. Business rules can be used to define target service levels and determine when tasks should be re-shuffled in a queue. The outcomes of the changes can be monitored real time through the real time reporting engine.

D. Worker Notification and Task Acknowledgement

One aspect of the TbTOC system is a method of notifying a health care worker of a task or a clinical result and recording their acknowledgement of the task/result. Notifications and acknowledgements provide an audit trail that allows the health care provider to determine who saw and was responsible for what task, and when. Notifications can be either be “fire-forget” messages with no acknowledgement or “request-response” messages requiring an acknowledgement by the worker of the task or result. The “fire-forget” messages may be informative notifications for non-critical items that do not require a response, such as a notification to an emergency department doctor that a patient has been sent to a particular hospital ward or that a wardsman has accepted a transport request. The “request-response” message may be critical notifications for patient safety. In one embodiment, the TbTOC system records the time of a transfer of care between health care workers (e.g., wardsman to radiology nurse) corresponding to the acknowledgement action.

Notification of the task or the result may be through multiple channels or devices depending on the health provider's technology and physical environment. Portable devices such as smart phones can be supported and email, automated voice message with IVR or SMS channels can also be used.

E. Dynamic Optimization of Workflow

A workflow management system according to an embodiment of the invention has learning capabilities and can make and adjust suggestions for workflow in accordance with learning. For example, a workflow management system may assess historical data and to identify popular task completion paths and paths with a higher risk of running into problems (e.g., blocking conditions and non-optimal outcomes). Path learning may also be correlated with various parameters such as time, date (e.g., calendar date or day of week), resource, task attributes, patient profile, and the like. Statistical calculations and analysis may be used to assess the significance of the parameters.

In one embodiment, the workflow management system views a workflow process globally, from end to end, rather than solely from a step-by-step viewpoint. The workflow management system provides an end-to-end description of a complete workflow and during runtime the workflow management system assesses feasibility of particular paths in the workflow according to resource availability and path learning. The system may check whether there are blocking conditions at future steps, and may suggest alternate paths to avoid blocking conditions. For example, the system may notify a user that a checkup with a particular doctor may be performed at any step, but the doctor is only on duty for a specific time period. The system may suggest a path in which the checkup is performed while the doctor is on duty.

As another example, a workflow may specify a sequence of actions to be performed in the order of A, then B, then C. However, the location where action B is performed may be at an opposite end of the healthcare facility from the locations where actions A and C are performed. The workflow management system may be aware of the distance between each location, or may recognize that A followed by C is a popular completion path, or that actions A and C are often performed concurrently or one right after the other, or that the path “A, then C, then B” typically produces a shorter treatment duration than the path “A, then B, then C.” The system may therefore suggest that the workflow sequence be changed to A, then C, then B.

The workflow management system may also provide estimated wait time or average handle time statistics for a next step in a workflow, and may suggest paths to reduce the duration of individual steps and/or total processing time for a patient over the entire treatment cycle. The system may reserve a place in the queue for the current task while other tasks are performed, until the current task is resumed.

The system may display a predicted completion path for a task to an end user, and suggest modifications to the path based on path learning and other known conditions. The system may also provide reasons for the modifications, such as the unavailability of a particular resource.

In one embodiment the workflow management system may also automatically implement alternate paths without waiting for user approval. A workflow may specify that a particular worker (or a worker with particular skills) must see the patient at the end of the patient flow. However, the system may be aware that by the time the patient flow is predicted to end, that worker will no longer be available. The system may have acquired such information by extracting the worker's schedule from the workload management engine 104 of FIG. 1A. The worker's schedule may indicate that the worker is only available before noon. As a result, the workflow management system dynamically assigns the task a higher priority in accordance with the information learned about the worker's schedule. The workflow management system therefore dynamically optimizes a workflow during runtime.

Path learning may therefore be used to dynamically optimize workflow outcomes according to a number of different goals, such as duration, quality of treatment, patient stress exposure, resource utilization, cost, and the like. For example, path learning may be correlated with a duration parameter (e.g., on an individual step basis or a global end-to-end basis), and the system may use statistical analysis to identify treatment paths that reduce or minimize duration. Path learning may also be correlated with a patient pain level parameter, and the system may use statistical analysis to identify paths that produce lower pain levels, based on feedback inputted by workers into the system.

According to an embodiment, the system may also make reservations for tasks to be performed at a later time. The reservation may be made based on the system's awareness of resource availability. For example, the system may consider a global end-to-end view of a workflow and recognize that a particular type of resource will be required in approximately thirty minutes. The system will request a reservation with the resource in thirty minutes. If the reservation is granted, the task will be performed by the resource at the reserved time. If the reservation is denied, the system may adjust the workflow by proposing an alternate path to the user. The adjusted workflow may include a reservation with the resource at another mutually available time and will return to the resource at the reserved time after other paths have been followed.

F. Patient Flow

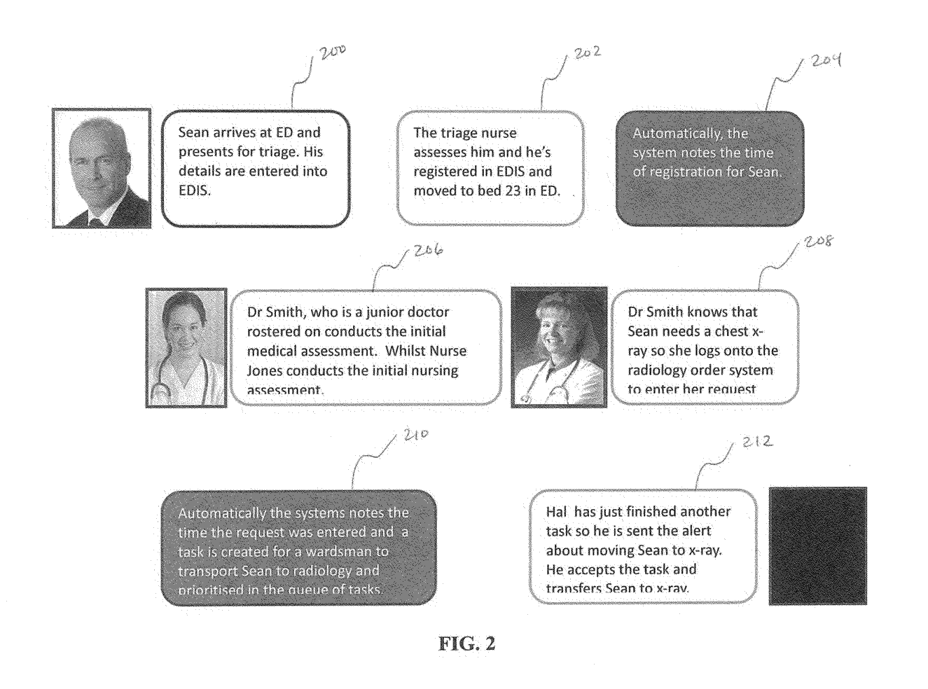

FIGS. 2-7 describe an exemplary use and implementation of a TbTOC system in a hospital in the context of an example patient (Sean) who arrives at the emergency department (ED) seeking treatment for chest pain. FIGS. 2-7 will also be described with reference to FIG. 1A, in which the clinical systems and enterprise systems represent those of the hospital described in FIGS. 2-7.

As shown in block 200 of FIG. 2, the patient arrives at the ED for triage. A health care worker enters information about the patient (e.g., name, age, address, symptoms) into the emergency department system or emergency department information system (EDIS) via the clinical portal 124 shown in FIG. IA. At block 202, a triage nurse assesses the patient and registers him in the EDIS. The TbTOC system “listens” for HL7 message events generated by the clinical systems 102 and uses the HL7 capture gateway 114 shown in FIG. 1A to capture the events without interruption to the source clinical systems or health care workers. Thus, the TbTOC system automatically collects and stores the time of the patient's registration as shown at block 204 and may also assign the patient an ID number. At blocks 206 and 208, a junior doctor, Dr. Smith, conducts an initial medical assessment and notes that the patient needs a chest x-ray. Dr. Smith accesses the radiography system 116 via the clinical portal 124 shown in FIG. IA to enter her x-ray request. The workload management engine 104 in FIG. 1A generates tasks based on events from the clinical systems 102. For example, in this case the TbTOC system automatically collects and stores the time of the x-ray request as shown at block 210 and automatically generates two tasks—an x-ray task and a transport task to transport the patient to the radiology department.

According to an embodiment, whenever a task is created, whether automatically by the TbTOC system or manually by a health care worker, the TbTOC system automatically collects and stores the creation date and time of the task. The TbTOC system also assigns an ID number to each task. Each work item or task also has various attributes that are internally accessible, for example, urgency level (e.g., priority or level or criticality), target service level, process type, and type of worker to perform the task. The urgency level (e.g., priority or level of criticality) may be determined based on the severity of the patient's condition. The target service level may be determined by the hospital and may be designed to meet a standard of care. The target service level may depend on the type of task and may be, for example, an amount of elapsed time that should not be exceeded before the work item is distributed to a worker. The process type refers to the health care process involved, for example, x-ray. The worker type assigns a particular category of health care worker to the task, for example, the transport task may designate a wardsman as the appropriate worker type and the x-ray task may designate an x-ray technician as the appropriate worker type.

After generating the tasks, the TbTOC system may assign the tasks for distribution based on the attributes. For example, the TbTOC system may place the x-ray task into an x-ray queue and the wardsman task into a wardsmen queue. Separate queues may be synchronized in order to meet target service levels. For example, the x-ray task may have a target service level of thirty minutes, and as the target service level approaches the thirty minute threshold (i.e., the elapsed time draws closer to the thirty minute limit), the corresponding transport task may be automatically re-prioritized to have a higher priority in the transport queue and the x-ray task may also be automatically re-prioritized to have a higher priority in the x-ray queue.

This process of automatic re-prioritization according to a status of a work item or task is referred to herein as “escalation.” According to an aspect of the present invention, escalation occurs not only on a single level, but occurs on multiple levels across multiple processes and tasks. Multiple escalation points may be generated for each process based on target service levels. For example, delays from triage to registration or vice versa may generate (or trigger) an escalation point. In another example, an escalation point may be between registration and moving the patient to a bed. There may also be an escalation point between an x-ray request being generated and the x-ray request being accepted or acknowledged. There may also be an escalation point for wardsman travel to or from the x-ray department. An escalation point may also exist between completion of the initial assessment report to completion of the x-ray and also for acknowledgement by a clinician. Notifications may be generated and sent to the clinician at both escalation points. As used herein, the term “escalation” may also refer to the process of adjusting a routing strategy for a work item according to a status of a work item or task. According to an aspect of embodiments of the present invention, escalation by the TbTOC system allows for automated, more intelligent downstream planning in health care workflows.

The TbTOC system also performs resource allocation by determining the best available worker (or resource) to perform each task, based on the task attributes as well as factors such as worker location, skills, and availability. In the context of resource allocation and distribution of work items, escalation may refer to the process of distributing a task to the next appropriate, available resource when the first identified resource is unavailable. At block 212 of FIG. 2, a wardsman, Hal, has used his portable device to indicate that he has just completed another task and is now available. Accordingly, the TbTOC system automatically sends him an alert (e.g., via his portable device) about the transport task for the patient Sean. The wardsman uses his portable device to accept the task. The TbTOC system automatically collects and stores the time of acceptance of the task. After the wardsman has transported the patient to radiology, the wardsman indicates his completion of the task (e.g., via his portable device). The TbTOC system automatically collects and stores the time of completion of the task.

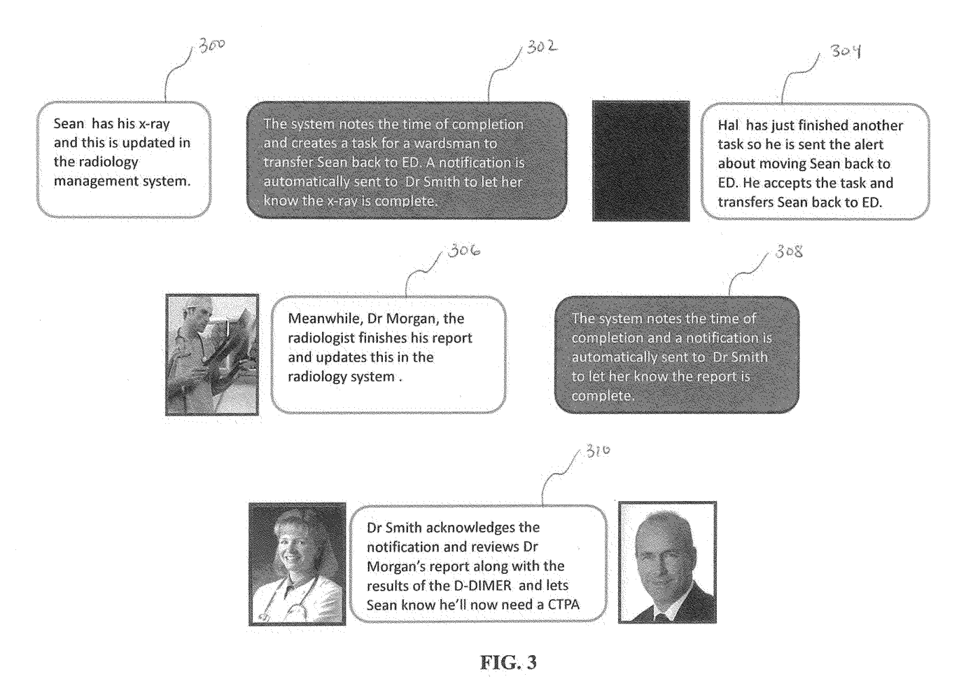

According to an embodiment, when a task is complete, a notification is sent to the next worker in the workflow to inform them that the task has been completed, so that they can commence the next task in the workflow. As shown at block 300 of FIG. 3, after the patient has his x-ray, the radiography system in FIG. 1A is updated to reflect the x-ray event. At block 302, the TbTOC system captures the event via the HL7 capture gateway 114 and creates another task, in this case a second transport task to transfer the patient back to the ED. In addition, a notification is automatically sent to the doctor via the voice or digital channel gateway 110 in FIG. 1A to let her know that the x-ray is complete.

At block 304 the wardsman, having just indicated his completion of another task, indicates his availability to the workload management engine 104 (e.g., via his portable device). Accordingly, the TbTOC system sends him an alert about the second transport task. The wardsman uses his portable device to accept the task. The TbTOC system automatically collects and stores the time of notification and the time of acceptance of the task. After the wardsman has transported the patient to radiology, the wardsman indicates his completion of the task (e.g., via his portable device). The TbTOC system automatically collects and stores the time of completion of the task.

Meanwhile, at block 306 the radiologist, Dr. Morgan, finishes his report concerning the x-ray and accesses the radiography system 116 via the clinical portal 124 in FIG. 1A to provide an update that the report is ready. According to an embodiment, a doctor or other worker may add notes to the report and images using their portable device (e.g., via a keypad or dictation into their portable device), which may be transmitted along with the report and images to the next worker in the workflow. The TbTOC system captures the event via the HL7 capture gateway 114 and automatically collects and stores the time of completion of the task. At block 308 the TbTOC system then automatically sends a notification to the junior doctor, Dr. Smith, that the report is complete. In one embodiment, the TbTOC system also automatically sends the report and accompanying x-ray images (or a secure link to the report and x-ray images) to Dr. Smith so that she can review them (e.g., on her portable device). At block 310, Dr. Smith acknowledges the notification (e.g., via her portable device), reviews the report and x-ray images, and determines a further course of action for the patient. The TbTOC system automatically collects and stores the time of notification and the time of acknowledgment.

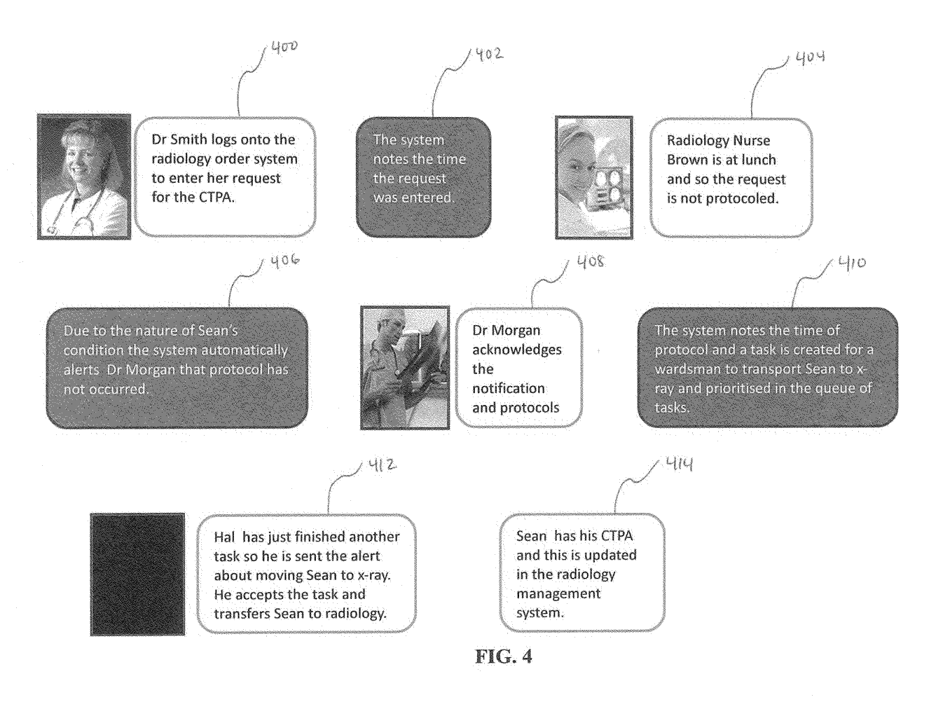

As shown in FIG. 4, Dr. Smith has determined that the patient needs a computed tomography pulmonary angiogram (CTPA). At block 400 Dr. Smith accesses the radiography system 116 via the clinical portal 124 in FIG. 1A and enters her request for a CTPA. At block 402 The TbTOC system captures the event via the HL7 capture gateway 114 and automatically collects and stores the time of the request. The TbTOC system then automatically generates a CTPA task and places the task in a CTPA queue. In this case as indicated at block 404 the radiology nurse, Nurse Brown, is away at lunch and so the request is not protocoled.

However, the critical nature of the patient's condition has been stored in the patient's information and forms part of the attributes for each task associated with the patient. Therefore, at block 406 the TbTOC system automatically escalates the CTPA task by alerting a different health care worker with the appropriate skills and location, Dr. Morgan, that protocol has not occurred. At block 408 Dr. Morgan acknowledges the notification (e.g., via his portable device) and protocols the request. At block 410 the TbTOC system automatically collects and stores the time of escalation, the time of notification, and the time of protocol.

The TbTOC system also creates a third transport task to transport the patient to the radiology department. At block 412 the wardsman, having just indicated his completion of another task, indicates his availability to the workload management engine 104 (e.g., via his portable device). Accordingly, the TbTOC system sends him an alert about the third transport task. The wardsman uses his portable device to accept the task. The TbTOC system automatically collects and stores the time of notification and the time of acceptance of the task. After the wardsman has transported the patient to radiology, the wardsman indicates his completion of the task (e.g., via his portable device). The TbTOC system automatically collects and stores the time of completion of the task. Alternatively, the TbTOC system may generate the third transport task along with the CTPA task, and the process of wardsman notification, acceptance, and transport may be concurrent with the escalation process described above.

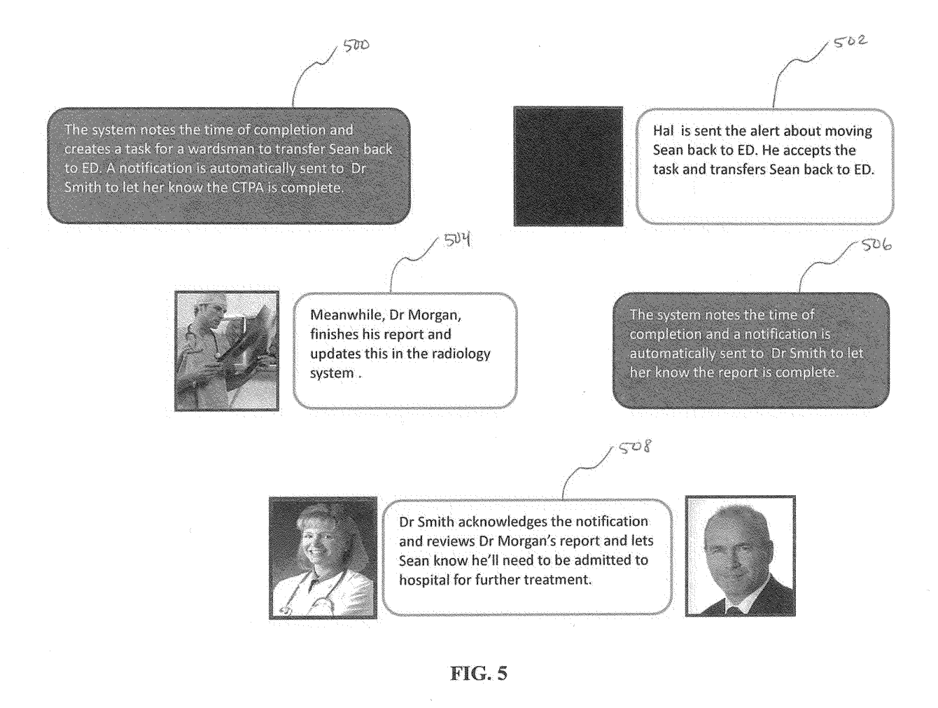

At block 414 after the patient has his CTPA, the radiography system 116 in FIG. 1A is updated to reflect the CTPA event. The TbTOC system captures the event via the HL7 capture gateway 114 and automatically collects and stores the time of completion of the task. As shown in FIG. 5 at block 500, the TbTOC system also creates a fourth transport task to transport the patient back to the ED. In addition, a notification is automatically sent to Dr. Smith via the voice or digital channel gateway 110 in FIG. 1A to let her know that the CTPA is complete.

At block 502 the wardsman, having just indicated his completion of another task, indicates his availability to the workload management engine 104 (e.g., via his portable device). Accordingly, the TbTOC system sends him an alert about the fourth transport task. The wardsman uses his portable device to accept the task. The TbTOC system automatically collects and stores the time of notification and the time of acceptance of the task. After the wardsman has transported the patient to the ED, the wardsman indicates his completion of the task (e.g., via his portable device). The TbTOC system automatically collects and stores the time of completion of the task.

Meanwhile, at block 504 the radiologist, Dr. Morgan, finishes his report concerning the CTPA and accesses the radiography system 116 via the clinical portal in FIG. 1A to provide an update that the report is ready. At block 506 the TbTOC system captures the event via the HL7 capture gateway 114 and automatically collects and stores the time of completion of the task. The TbTOC system then automatically sends a notification to the junior doctor, Dr. Smith, that the report is complete. In one embodiment, the TbTOC system also automatically sends the report and accompanying CTPA images to Dr. Smith so that she can review them (e.g., on her portable device). At block 508 Dr. Smith acknowledges the notification (e.g., via her portable device), reviews the report and CTPA images, and determines a further course of action for the patient. The TbTOC system automatically collects and stores the time of notification and the time of acknowledgment.

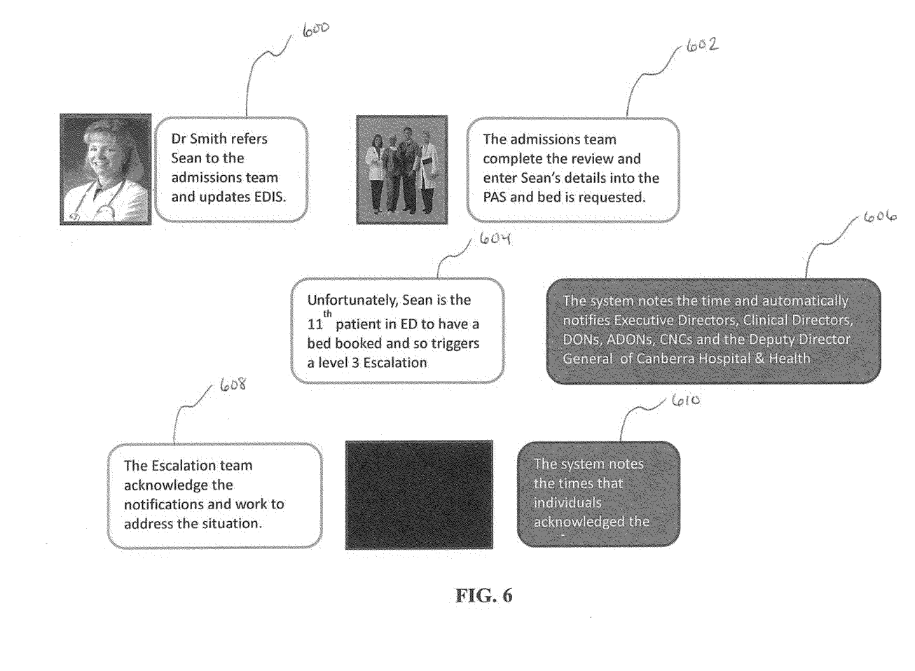

In this case, Dr. Smith has determined that the patient needs to be admitted to the hospital for further treatment. As shown in FIG. 6 at block 600, the doctor refers the patient to the admissions team and accesses the clinical portal 124 in FIG. 1A to update the EDIS with the referral. The TbTOC system captures the event via the HL7 capture gateway 114 and automatically collects and stores the time of the referral. The TbTOC system then automatically sends a notification to the admissions team via the voice or digital channel gateway 110 in FIG. 1A to let them know of the referral. The admissions team acknowledges the notification. The TbTOC system automatically collects and stores the time of notification and the time of acknowledgment.

At block 602 The admissions team accesses the clinical portal 124 to review the patient's information and enter the patient's details into the Patient Administration System 118 in FIG. 1A. The admissions team also enters a bed request. The TbTOC system captures the event via the voice or digital channel gateway 110 and automatically collects and stores the time of the request. In one embodiment, there is a target service level for the number of beds, and an escalation point occurs at ten beds. As shown at block 604 since Sean is the eleventh patient in the ED to request a bed, the TbTOC system automatically triggers an escalation response. At block 606 the TbTOC system automatically collects and stores the time of the escalation point trigger, and automatically notifies the escalation team of the situation via the voice or digital channel gateway 110. The escalation team may include more senior-level authorities such as Executive Directors, Clinical Directors, Directors of Nursing (DONs), Assistant Directors of Nursing (ADONs), CNCs, and the Deputy Director General of the Hospital & Health Services. At block 608 one or more members of the escalation team acknowledges the notification and works to address the situation. At block 610 the TbTOC system automatically collects and stores the time of notification and the time of acknowledgement by individuals of the escalation team.

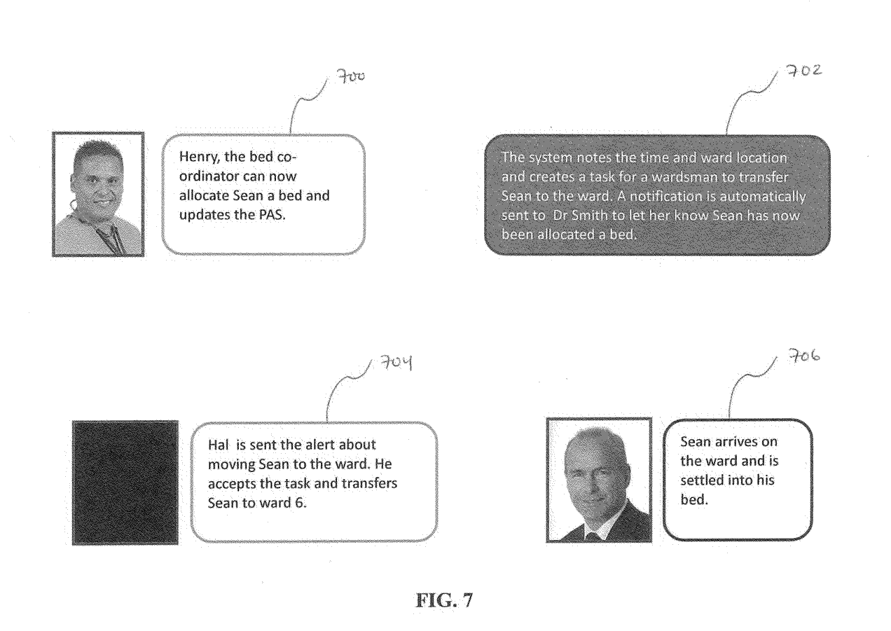

In FIG. 7, at block 700 the bed coordinator, Henry, allocates a bed for the patient and accesses the clinical portal 124 to update the Patient Administration System 118 with the bed allocation. At block 702 the TbTOC system captures the event via the HL7 capture gateway 114 and automatically collects and stores the time of the bed allocation, and may also collect and store relevant information from the Patient Administration System 118 such as the bed number and ward location. The TbTOC system then automatically generates a fifth transport task to transport the patient to the appropriate ward. In addition, a notification is automatically sent to Dr. Smith via the voice or digital channel gateway 110 in FIG. 1A to let her know that the patient has been allocated a bed.

At block 704 the wardsman, having just indicated his completion of another task, indicates his availability to the workload management system 104 (e.g., via his portable device). Accordingly, the TbTOC system sends him an alert about the fifth transport task. The wardsman uses his portable device to accept the task. The TbTOC system automatically collects and stores the time of notification and the time of acceptance of the task. After the wardsman has transported the patient to the appropriate ward, the wardsman indicates his completion of the task (e.g., via his portable device). The TbTOC system automatically collects and stores the time of completion of the task. At block 706 the patient arrives at the ward and is settled to his bed.

According to embodiments of the present invention, the TbTOC system facilities all stages of patient flow and is not limited to the above-described stages of triage and registration, initial assessment and x-ray, subsequent assessment and CTPA, and admission to hospital. For example, the TbTOC system can also facilitate patient discharge by automatically finding and connecting with the appropriate caregivers to reduce the time it takes to discharge the patient. Once the discharge is approved, the TbTOC system can notify the affected hospital departments (e.g., housekeeping, pharmacy, food services and patient transportation) of the pending patient release.

Therefore, according to an aspect of the present invention, at each step of the patient workflow a particular health care worker is responsible for the patient's care. The workers indicate their acceptance of the responsibility at each stage by acknowledging notifications and accepting tasks.

In addition, the TbTOC system can send automated notifications for any number of different tasks or events and can also automate the delivery of urgent patient information (e.g., critical laboratory results, availability of a new prescription, completion of a radiology study, or confirmation of insurance coverage) to doctors as it becomes available.

G. Reporting

According to an embodiment, the TbTOC system provides mature real time and historical reporting and analytical functions for detailed insights into operations.

The TbTOC system natively supports real time reporting of task states and the efficiencies of operations being conducted by health care workers. Ward and department administrators can view tasks being performed within their ward or department using the real time reporting desktop client. This data can also be used for handover sessions at the end of shifts.

Operational escalations and bottle necks can be visually identified in a desktop client by administrative staff. Alarms can be configured in the desktop client to trigger when operational and performance indicators reach a threshold. Such alarms may be used in addition to the automatic notifications.

Managers of the health care provider may access a moment in time view on all tasks being performed across their organization. They can get quick insight into workforce efficiencies, task backlogs, and service level compliance from tasks managed in the workload management engine global task list. Real time data can also be used for feasibility testing of new service delivery standards.

For historical reporting, all task interactions and state changes may be managed in a centralized database or data mart as part of the TbTOC system. Data analytic services produce generic reports from the database or data mart that can be customized by a report designer and automatically distributed via email to recipients. Example reports are (from high to low level detail): Average Task Time by Operation (by day, month, quarter, year), Staff efficiency report (inactive verses active), Tasks or operations created and finished (within time or overdue), Tasks completed (and percentage of tasks) by department, Tasks Created, Pending and Overdue Tasks by day or shift (note useful for shift handover), and Patient Activity Report (all tasks created as part of the patient flow). Reporting may also provide the ability to implement continuous improvement models in patient flow and redesign, and to identify areas of future innovation in work management and process design. Therefore, aspects of the present invention may enable alignment and development of training and education approaches to support future state models.

According to embodiments of the present invention, the system also provides an auditable trail for all tasks, which allows for collection of more granular data at the task level. As a result, transparency can be provided into: resources efficiencies, workload distribution, lapsed time to complete process, productivity levels and process efficiencies, process compliance, and patient data access protocols (privacy). Further, individual tasks can be measured against overall outputs, while performance metrics may be viewed in the context of operational cost. In one embodiment, the TbTOC system provides the health care provider with visibility over key processes so that they can track performance and evaluate the results of their improvement initiatives.

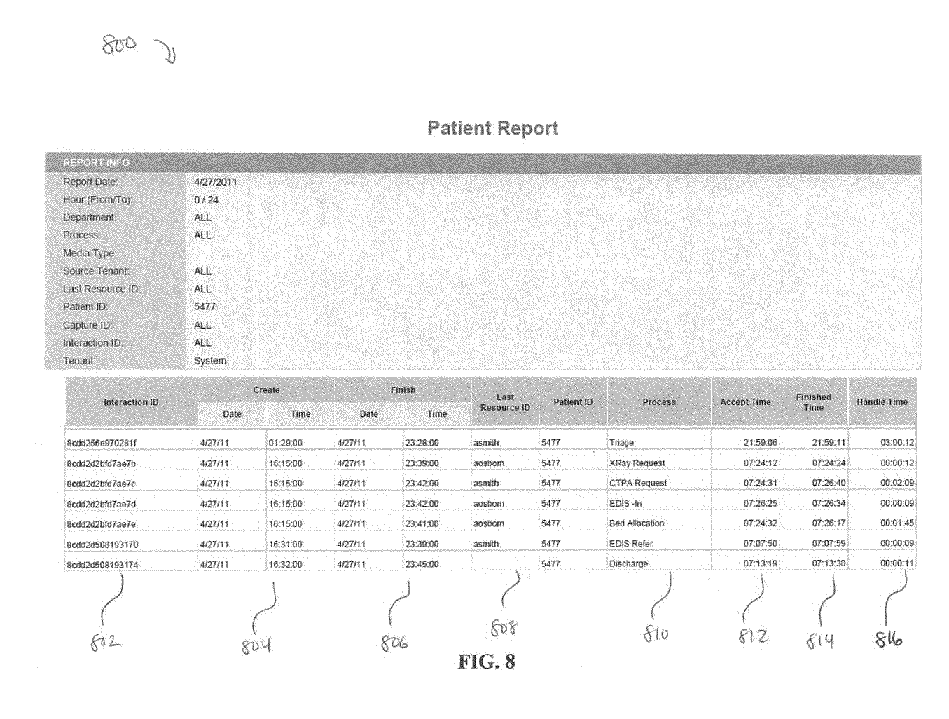

FIGS. 8-19 illustrate reports that may be generated by the TbTOC system according to example embodiments. FIG. 8 shows a patient report for patient ID 5477. The report lists all interactions for patient ID 5477 on Apr. 27, 2011. The Interaction ID column 802 lists the Interaction ID for each task and the recorded creation date and time and finish (or completion) date and time is displayed for each task in columns 804 and 806, respectively. The Process type (e.g., Triage, XRay Request, CTPA Request, EDIS-In, Bed Allocation, EDIS Refer, and Discharge) for each task is specified in column 810. The Last Resource ID in column 808 identifies the last health care worker associated with the task, and the worker's acceptance time, finished time, and handle time (e.g., duration of time between acceptance to finish) for the task are displayed in columns 812, 814, and 816, respectively. The detailed task information may be sorted according to any one of the columns shown in FIG. 8. Patient reports such as the one in FIG. 8 provide visibility of data about an individual patient across a treatment cycle by providing detailed information about each task (or interaction).

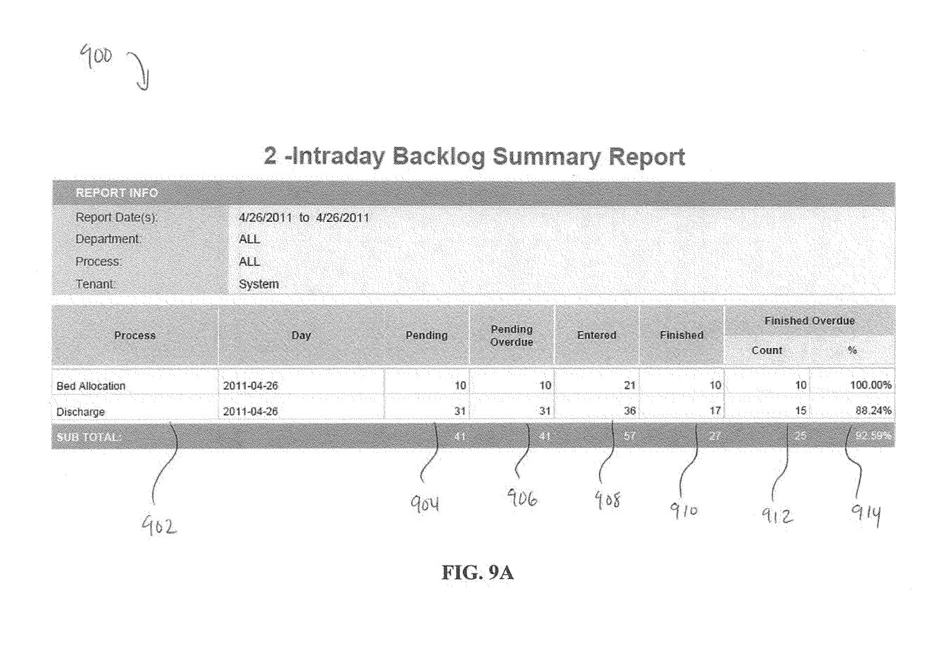

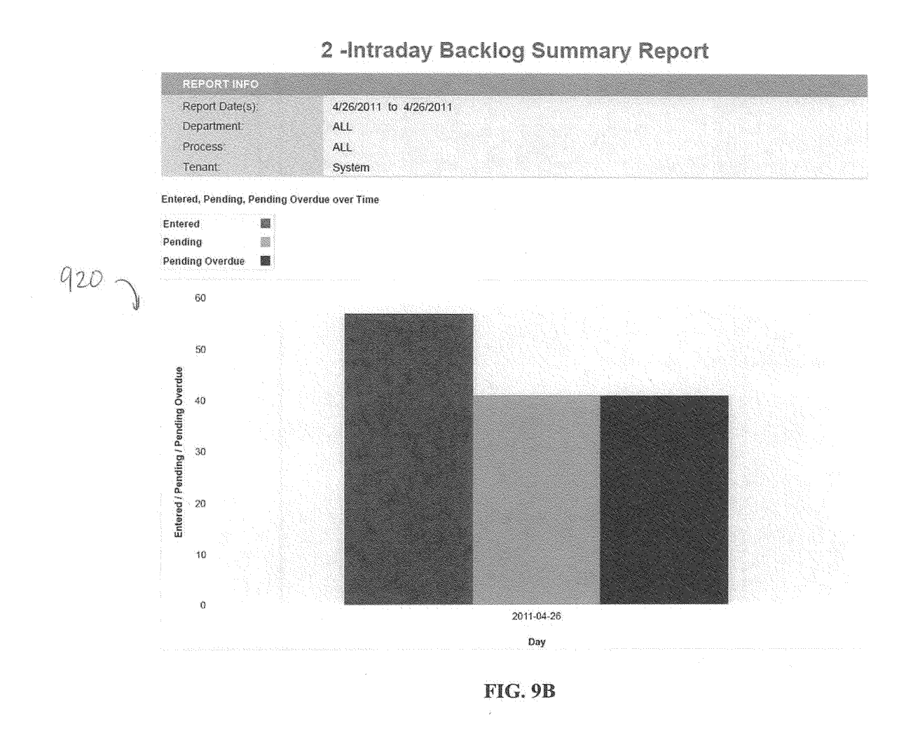

FIGS. 9A and 9B show intraday backlog summary reports for two processes, Bed Allocation and Discharge, for a particular day or reporting interval. The backlog summary report 900 of FIG. 9A provides a snapshot of the task backlog for Apr. 26, 2011. For each process identified in column 902, the report shows how many tasks are currently pending, how many tasks are currently overdue, and how many of the completed tasks were overdue. The Pending column 904 shows the current number of tasks that are pending (e.g., where the tasks' status is Queued, Assigned, or Held) at the end of the reporting interval. The Pending Overdue column 906 shows the current number of pending tasks that were overdue at the end of the reporting interval. According to one embodiment, a task is considered overdue when the target service level due date/time has been missed. The Entered column 908 shows the total number of new tasks of this classification that were submitted to the workload management engine during the reporting interval. The Finished column 910 shows the total number of tasks of this classification that were completed during the reporting interval. The Count Finished Overdue column 912 shows the total number of completed tasks of this classification that had been overdue during the reporting interval. The % Finished Overdue 914 column shows the percentage of completed tasks of this classification that had been overdue during the reporting interval.

The backlog summary report 920 of FIG. 9B plots the total number of entered, pending, and pending overdue tasks in three bars of a bar chart for each reporting interval. Backlog reports such as those in FIGS. 9A and 9B can be used to assess the backlog for certain processes at the end of a shift and before handover to the next shift. The spikes, patterns, and trends in the reports may be further analyzed on a task-by-task basis or an individual worker basis. A health care provider may consider rearranging the queue if the number of overdue tasks is disproportionate.

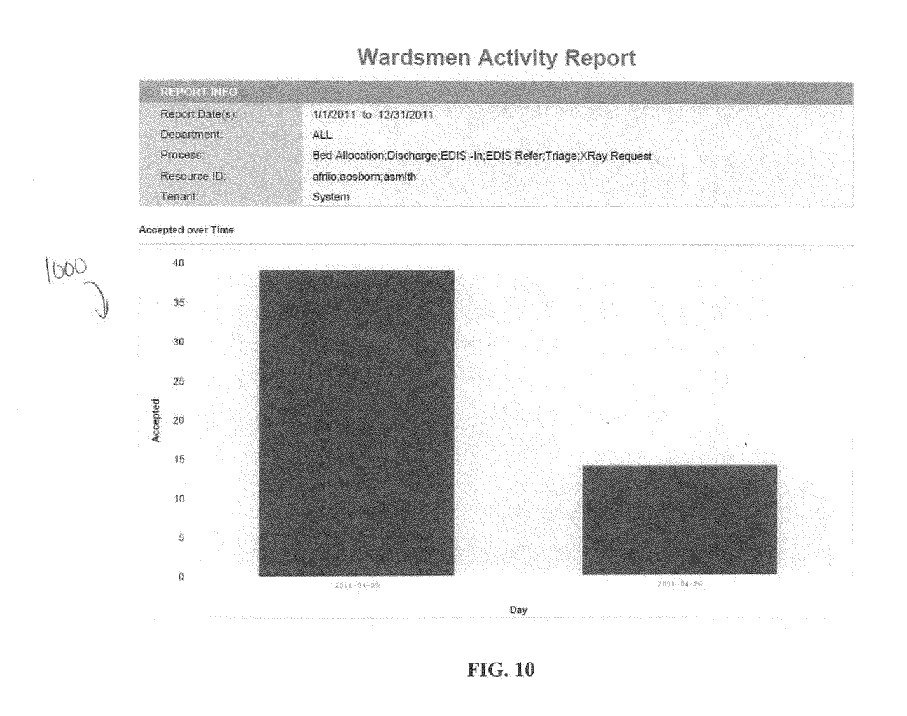

FIG. 10 shows a worker activity report 1000 for wardsmen during the year 2011. The bar chart (or graph) depicts the number of tasks accepted by wardsmen over time for the processes of Bed Allocation, Discharge, EDIS-In, EMS Refer, Triage, and XRay Request. In the example shown, a higher number of tasks were accepted by wardsmen on Apr. 25, 2011 than on Apr. 26, 2011. Activity reports such as the one in FIG. 10 can provide information about workforce productivity.

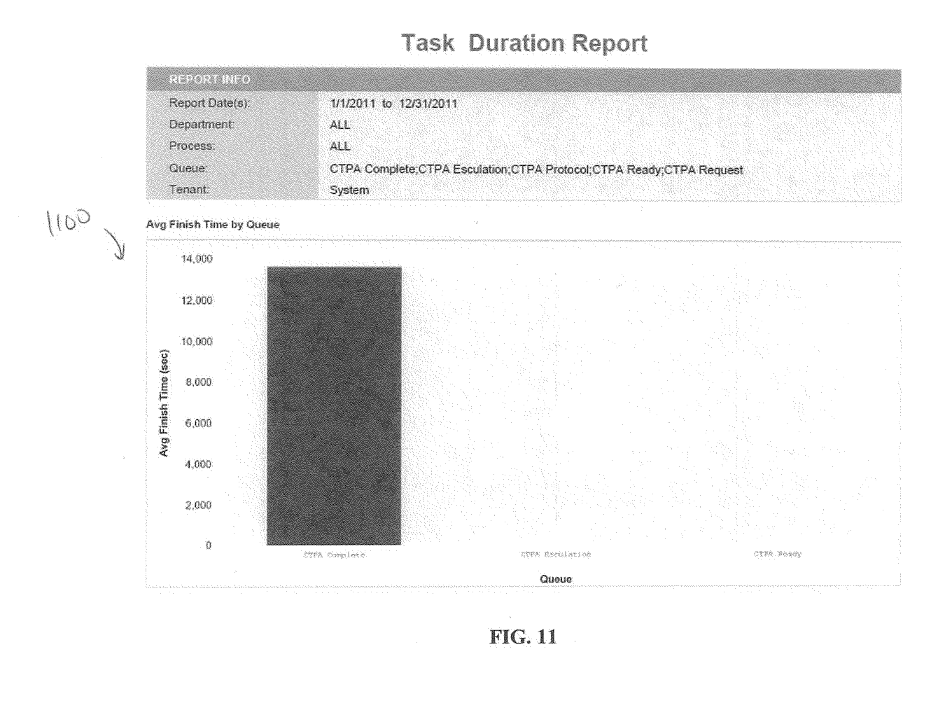

FIG. 11 shows a task duration report of average task finish time in seconds organized by queue for the year 2011. The queues include CTPA Complete, CTPA Escalation, CTPA Protocol, CTPA Ready, and CTPA Request. In the example shown, the average finish time to complete tasks in the CTPA Complete queue was between 12,000 and 14,000 seconds. Task duration reports such as the one in FIG. 11 provide transparency about time and task completion, giving insight into efficiency.

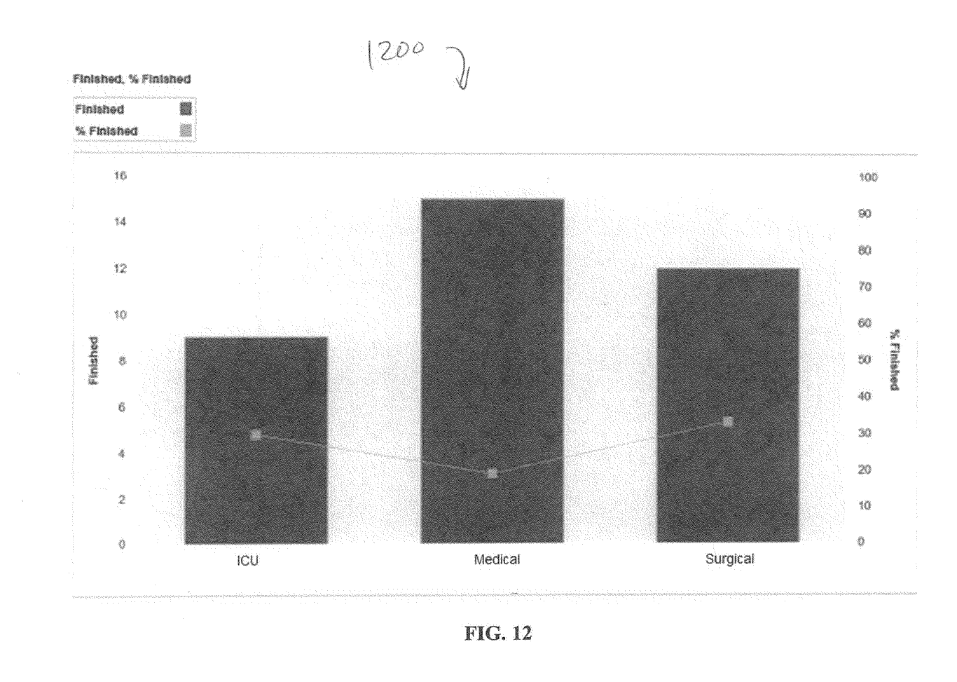

FIG. 12 shows a task completion report 1200 organized by patient category (e.g., ICU, Medical, Surgical). The bars represent the number of finished (or completed) tasks for each patient category, and the line chart represents the percentage of finished tasks for each patient category relative to the total number of tasks for that category. In the example shown, the more tasks were completed for medical patients than for ICU and surgical patients. However, medical patients had the lowest overall percentage of finished tasks among the three categories. Completion reports such as the one shown in FIG. 12 can be used to identify areas of workflow improvement.

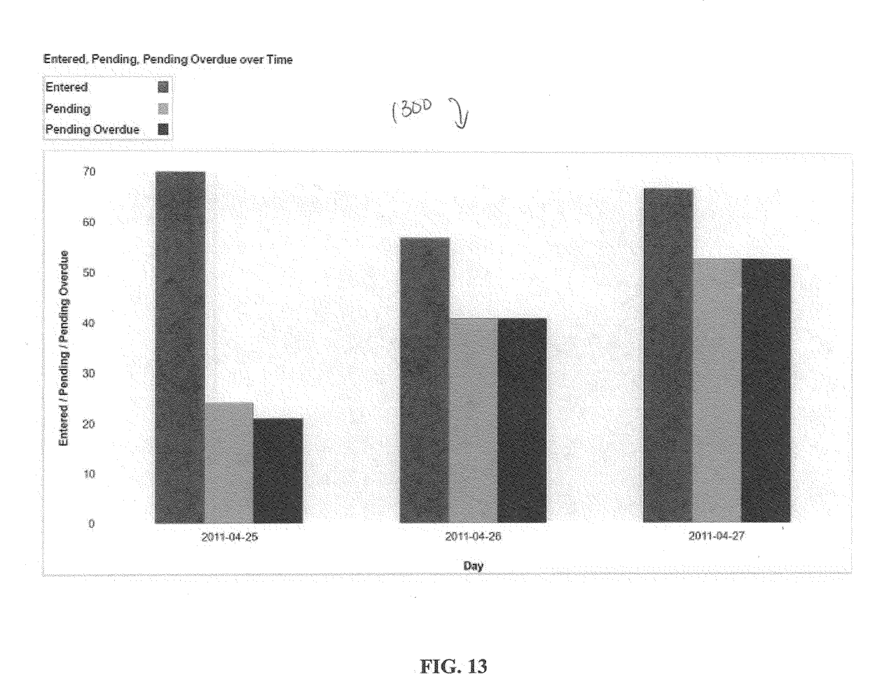

FIG. 13 shows a report 1300 of pending tasks categorized by status (e.g., Entered, Pending, and Pending Overdue) and organized by date. In the example shown, the number of Pending and Pending Overdue tasks increased between Apr. 25, 2011 and Apr. 27, 2011. The graph also demonstrates the changing ratio of Entered tasks to Pending and Pending Overdue tasks over the three days. Reports such as the one shown in FIG. 13 provide visibility into workflow trends over time.

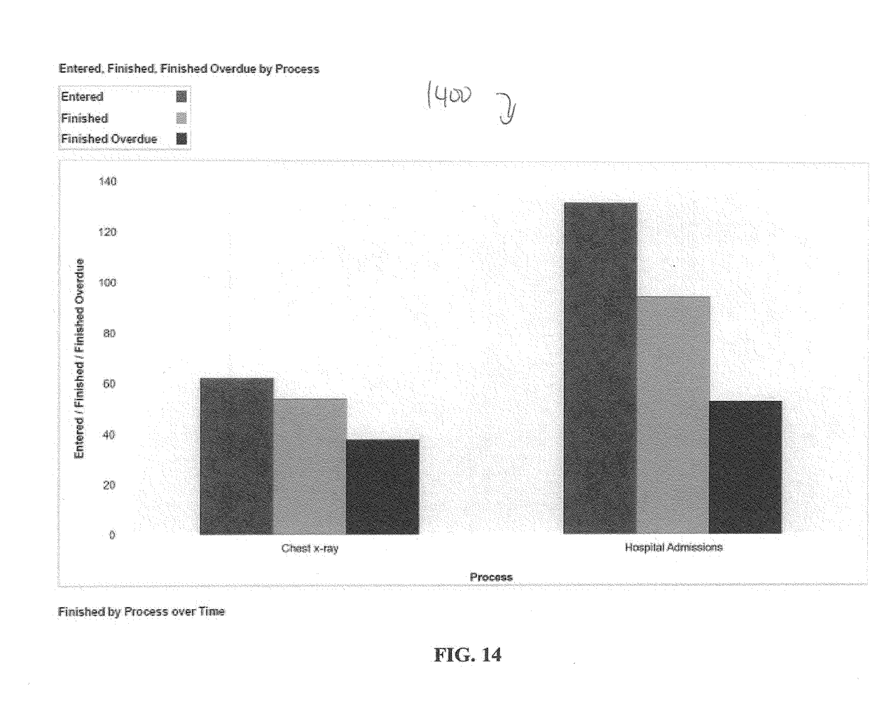

FIG. 14 shows a report 1400 in which tasks are categorized by status (e.g., Entered, Finished, and Finished Overdue) and organized by Process (e.g., Chest x-ray and Hospital Admissions). In the example shown, the overall numbers of Entered, Finished, and Finished Overdue tasks for Hospital Admissions is higher than those of Chest x-ray. Reports such as the one shown in FIG. 14 provide visibility into process volume and performance.

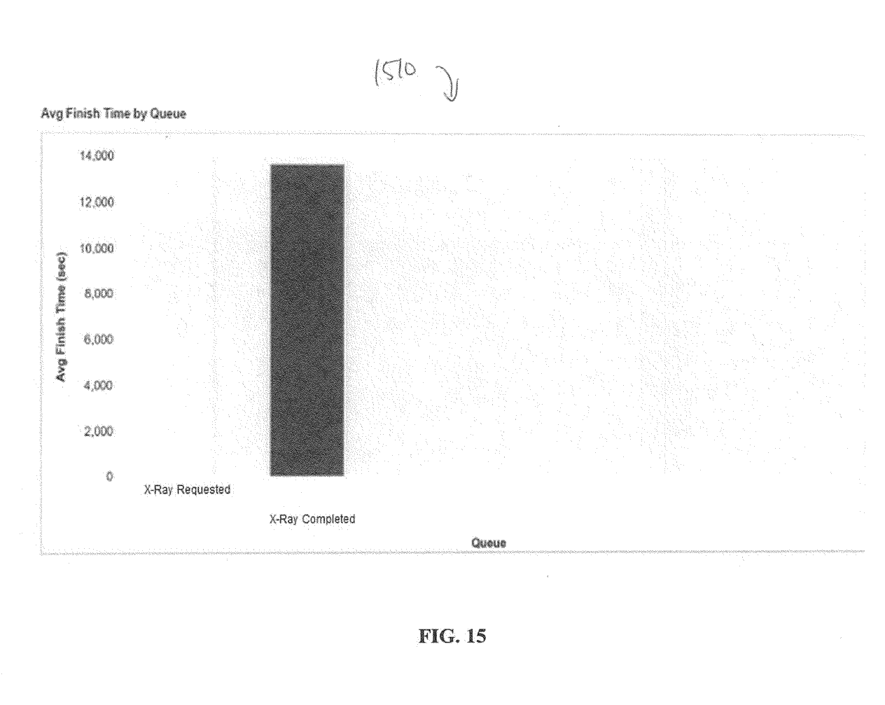

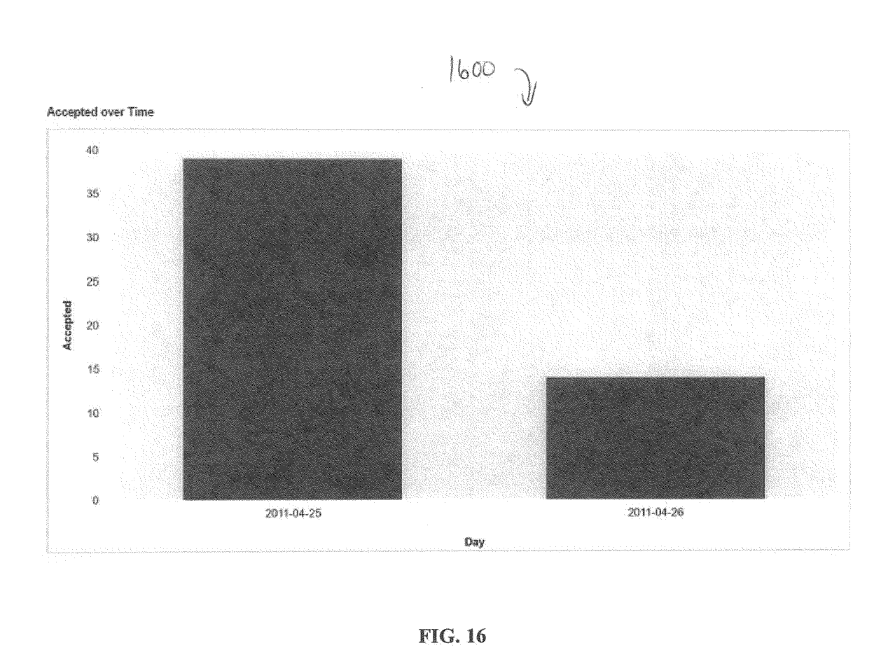

The report 1510 of FIG. 15 shows average finish time per queue. For example, the graph shows an average finish time of between 12,000 and 14,000 seconds for the queue X-Ray Completed. FIG. 16 shows a staff performance report 1600 of the number of tasks accepted over time. In the example shown, a higher number of tasks were accepted on Apr. 25, 2011 than on Apr. 26, 2011, which may indicate a decline in staff performance over the two days.

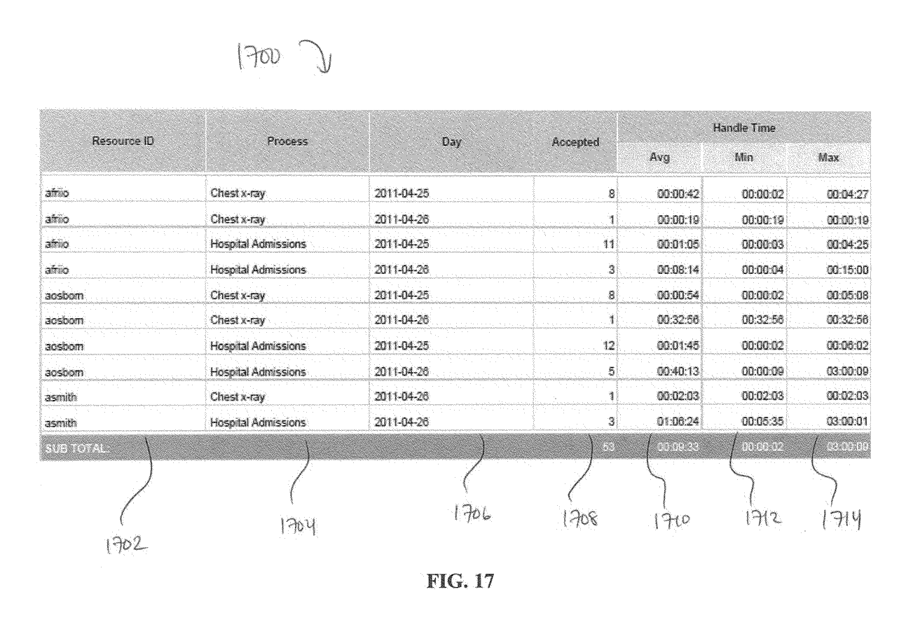

FIG. 17 shows another form of staff performance report, in which handle time is provided for different workers and processes. The report 1700 displays the Resource ID of each worker in column 1702, Process type (e.g., Chest x-ray, Hospital Admissions) in column 1704, date in column 1706, number of tasks accepted in column 1708, and Handle Time statistics for the day (e.g., average handle time in column 1710, minimum handle time in column 1712, and maximum handle time in column 1714). For example, as shown in the first row, the worker identified by Resource ID “afriio” accepted 8 tasks related to the Chest x-ray process on Apr. 25, 2011, and handled those tasks within 42 seconds on average. The worker's minimum handle time was 2 seconds and maximum handle time was 4 minutes and 27 seconds. As shown in the second row of the report, on the following day, the same worker accepted 1 Chest x-ray task and handled that task within 19 seconds. The average, minimum, and maximum handle times are the same because only 1 Chest x-ray task was accepted by the worker that day. Performance reports such as the one in FIG. 17 provide insight into individual worker efficiency on a process basis over time.

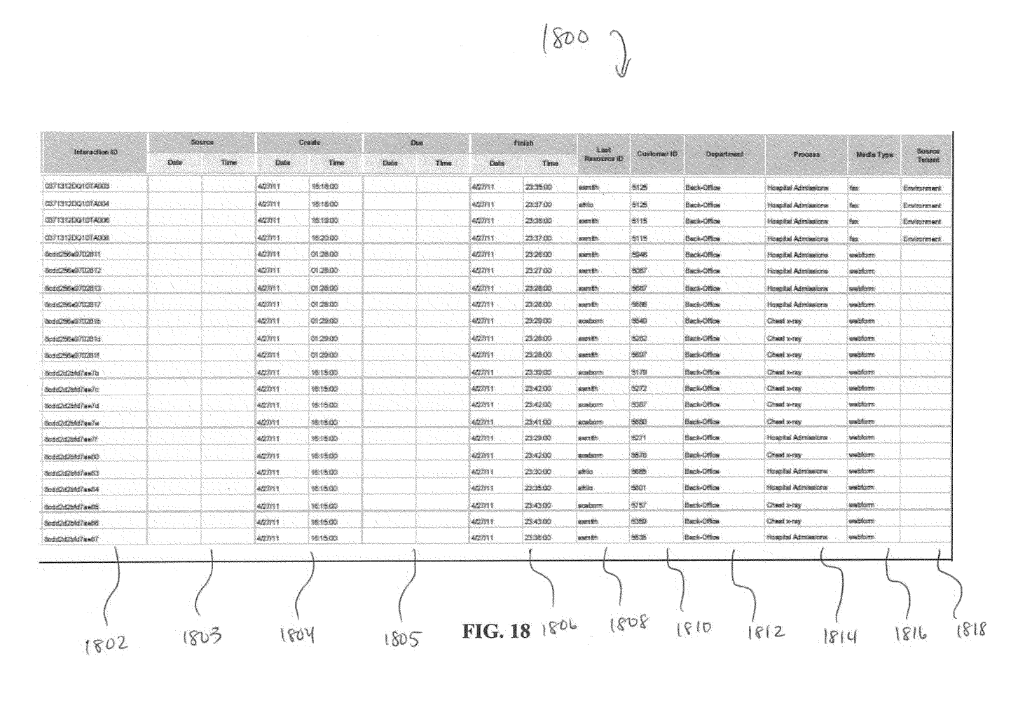

FIG. 18 shows a task detail report 1800. The Interaction ID, create time, and finish time for each task is displayed in columns 1802, 1804 and 1806, respectively. This data may be automatically collected and stored by the TbTOC system as described above with reference to FIGS. 1-7. In addition, the TbTOC system may also collect and store the date and time of the corresponding event capture from the source clinical system (such data may be displayed in the Source column 1803). A target service level due date and time may also be displayed for each task in the Due column 1805. The Last Resource ID in column 1808 identifies the last worker associated with the task, and the patient ID (shown as Customer ID) of the patient associated with the task is identified in column 1810. Also shown are the Department, Process type, Media Type, and Source Tenant (e.g., the name of the source clinical system from which the event was captured) in columns 1812, 1814, 1816, and 1818, respectively. This level of granularity can be used to provide visibility into a range of performance indicators.

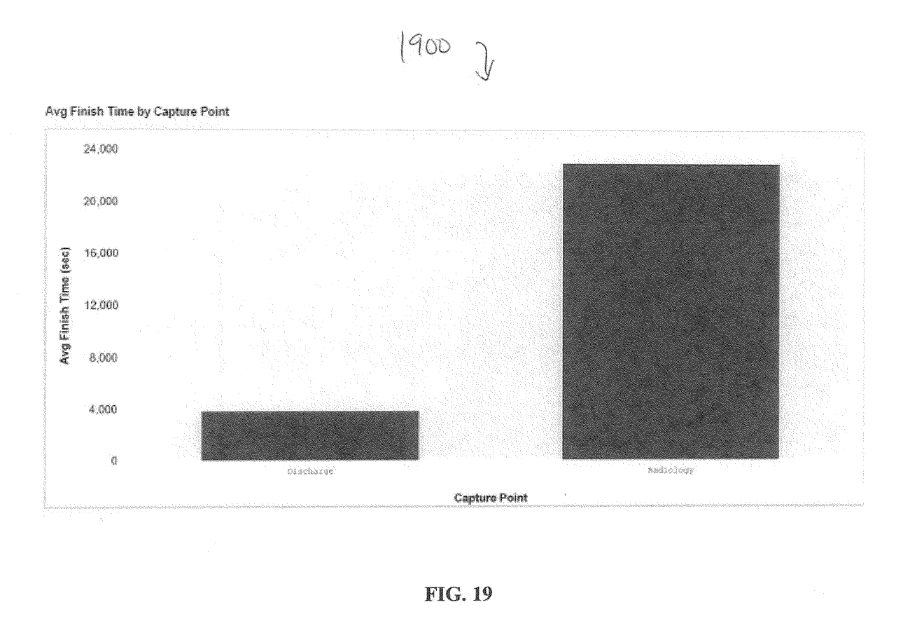

The report 1900 of FIG. 19 shows task duration (or average finish time) by capture point. According to an embodiment, a capture point is a system interface configured to capture events occurring in an external clinical system. A process may be defined in the workload management engine and associated to a parent capture point. The workload management engine determines which process the event is associated with from the metadata received from the capture point. In FIG. 19, the report displays the events corresponding to two capture points. In the example shown, the average finish time for tasks at the radiology capture point is higher than the average finish time for tasks at the discharge capture point.

According to an aspect of the present invention, reports such as those in FIGS. 8-19 provide transparency into staff efficiency and tasks across health care delivery processes to reduce delays in accessing information, reduce delays in patient care, and reduce medical errors.

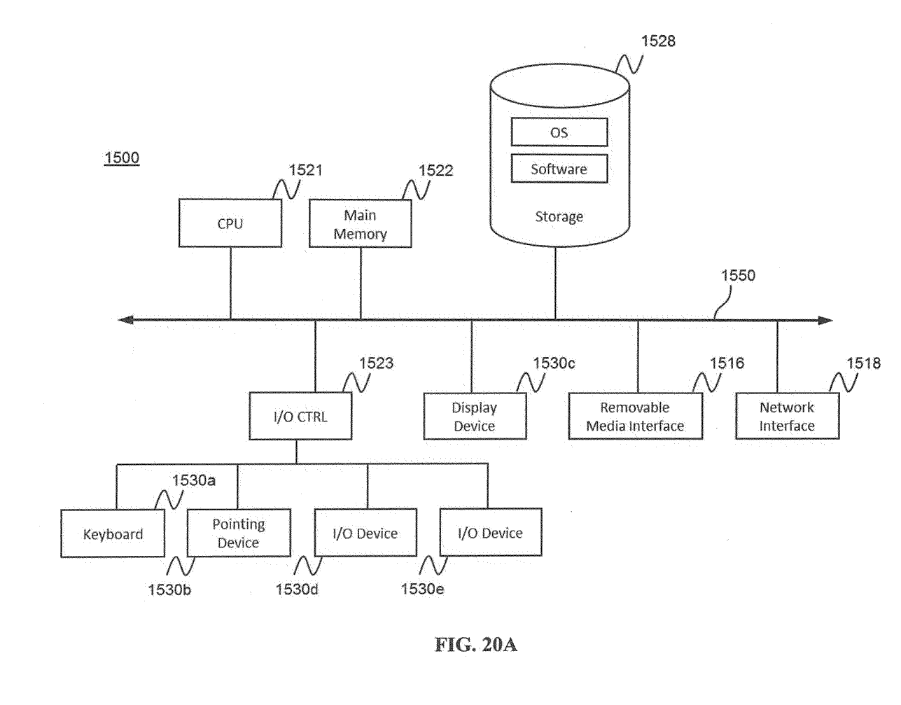

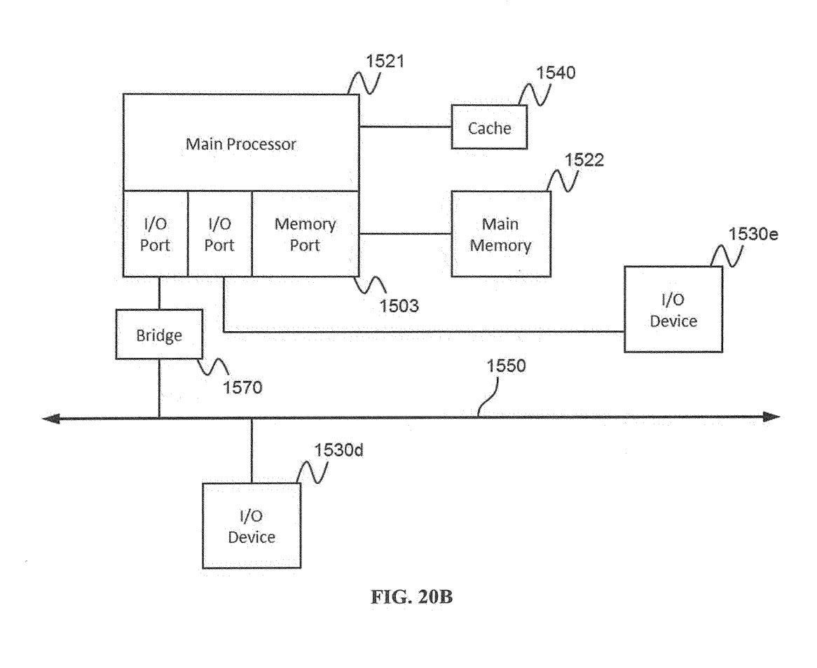

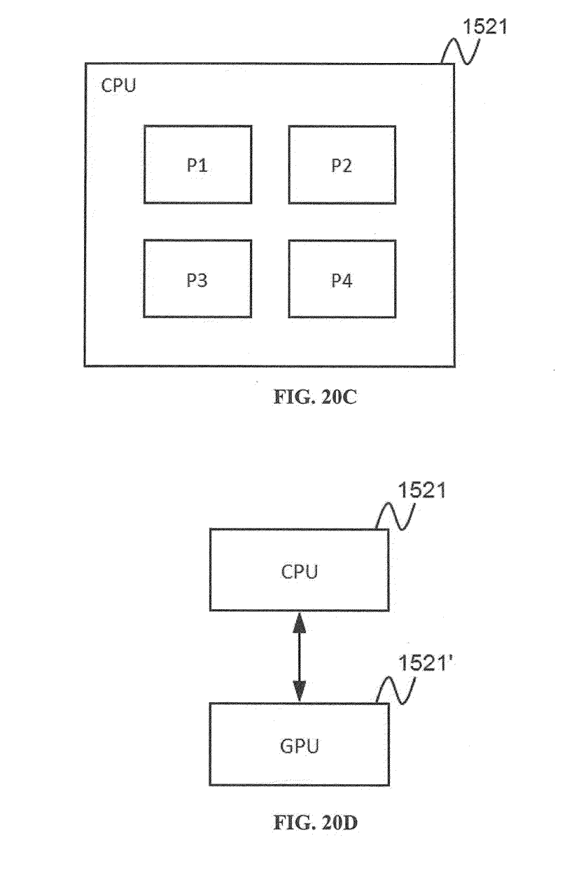

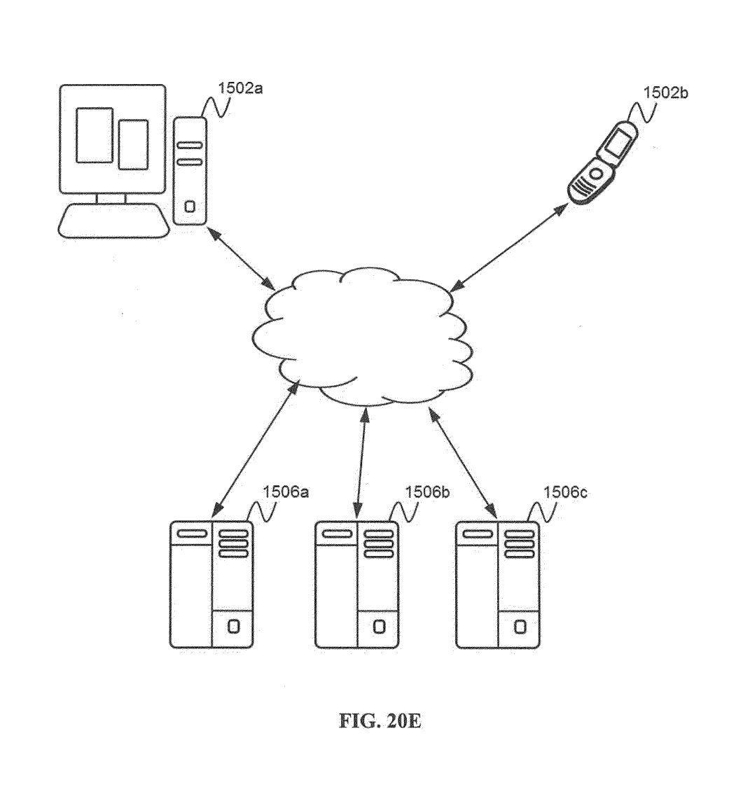

Each of the various servers, controllers, switches, gateways, engines, and/or modules (collectively referred to as servers) in the afore-described figures may be a process or thread, running on one or more processors, in one or more computing devices 1500 (e.g., FIG. 20A, FIG. 20B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules of the healthcare provider may include servers, and other modules.

The various servers may be located on a computing device on-site at the same physical location as the healthcare provider or may be located off-site (or in the cloud) in a geographically different location, e.g., in a remote data center, connected to the healthcare provider via a network such as the Internet. In addition, some of the servers may be located in a computing device on-site at the healthcare provider while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the interne using various protocols, such as by exchanging data using encoded in extensible markup language (XML) or JavaScript Object notation (JSON).

FIG. 20A and FIG. 20B depict block diagrams of a computing device 1500 as may be employed in exemplary embodiments of the present invention. Each computing device 1500 includes a central processing unit 1521 and a main memory unit 1522. As shown in FIG. 20A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 20B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 20A, the central processing unit 1521 communicates with the main memory 1522 via a system bus 1550. As shown in FIG. 20B, the central processing unit 1521 may also communicate directly with the main memory 1522 via a memory port 1503.

FIG. 20B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 20A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 20B depicts an embodiment of a computer 1500 in which the central processing unit 1521 communicates directly with I/O device 1530e. FIG. 20B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 20A, may control the I/O devices. The I/O controller may control one or more I/O devices such as a keyboard 1530a and a pointing device 1530b, e.g., a mouse or optical pen.

Referring again to FIG. 20A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 20A and FIG. 20B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 20C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 20D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 20E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 20E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 20E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

It is the Applicant's intention to cover by claims all such uses of the invention and those changes and modifications which could be made to the embodiments of the invention herein chosen for the purpose of disclosure without departing from the spirit and scope of the invention. For instance, although the examples used for the various embodiments are focused on the hospital setting, a person of skill in the art should recognize that the embodiments of the present invention are not limited to the hospital setting and may extend to other types of health care settings, including, without limitation, a medical office, a mobile medical unit, and the like. Additionally, notification concerning records and reports can take the form of links back to data held in external clinical systems, instead of or in addition to the actual record or report itself. The particular manner in which data and information are reported to the user may also differ from that shown in FIGS. 8-19. Thus, the present embodiments of the invention should be considered in all respects as illustrative and not restrictive, the scope of the invention to be indicated by claims and their equivalents rather than the foregoing description.

1. A workflow management system, comprising:
a processor; and
a memory, wherein the memory stores instructions that, when executed by the processor, cause the processor to:
identify an event received from an external system;
generate a work item corresponding to the event, the work item having a plurality of attributes;
assign the work item for distribution based on the attributes; and
adjust at least one of a priority or a routing strategy for the work item according to a status of the work item.

2. The workflow management system of claim 1, wherein the attributes comprise at least one of an urgency level, a target service level, a process type, or type of worker to perform the Work item.

3. The workflow management system of claim 2, wherein the target service level corresponds to an amount of elapsed time before the work item is distributed to a worker.

4. The workflow management system of claim 2, wherein the status of the work item comprises information about an approaching threshold of the target service level.

5. The workflow management system of claim 1, wherein the instructions, when executed, further cause the processor to send notifications to and receive acknowledgements from the worker, the notifications indicating a status of a work item.

6. The workflow management system of claim 5, wherein the routing strategy for the work item is adjusted by sending a notification to a different worker.

7. The workflow management system of claim 1, wherein the instructions, when executed, further cause the processor to receive a record corresponding to the work item, and send a notification to a next worker in the workflow when the record is received.

8. The workflow management system of claim 7, wherein the status of the work item comprises information about availability of the record.

9. The workflow management system of claim 1, wherein the priority or the routing strategy for the work item is adjusted based on business rules.

10. The workflow management system of claim 1, wherein the instructions, when executed, further cause the processor to distribute the work item to a worker based on the worker's skills and availability.

11. A method for workflow management, the method comprising:
identifying, by one or more processors, an event received from an external system;
generating, by the one or more processors, a work item corresponding to the event, the work item having a plurality of attributes;
assigning, by the one or more processors, the work item for distribution based on the attributes; and
adjusting, by the one or more processors, at least one of a priority or a routing strategy for the work item according to a status of the work item.

12. The method of claim 11, wherein the attributes comprise at least one of an urgency level, a target service level, a process type, or type of worker to perform the work item.

13. The method of claim 12, wherein the target service level corresponds to an amount of elapsed time before the work item is distributed to a worker.

14. The method of claim 12, wherein the status of the work item comprises information about an approaching threshold of the target service level.

15. The method of claim 11, further comprising sending, by the one or more processors, notifications to the worker and receiving, by the one or more processors, acknowledgements from the worker, the notifications indicating a status of a work item.

16. The method of claim 15, wherein the routing strategy for the work item is adjusted by sending a notification to a different worker.

17. The method of claim 11, further comprising receiving, by the one or more processors, a record corresponding to the work item, and generating, by the one or more processors, a notification when the record is received.

18. The method of claim 17, wherein the status of the work item comprises information about availability of the record.

19. The method of claim 11, wherein the priority or the routing strategy for the work item is adjusted based on business rules.

20. The method of claim 11, further comprising distributing, by the one or more processors, the work item to a worker based on the worker's skills and availability.
